(19) United States
(12) Patent Application Publication
(10) Pub. No.: US 2002/0187375 A1
(43) Pub. Date: Dec. 12, 2002

(54) Fuel cell installation and method for operating a fuel cell installation

(76) Inventors: Manfred Baldauf, Erlangen (DE); Rolf Bruck, Bergisch-Gladbach (DE); Armin Datz, Poxdorf (DE); Ulrich Gebhardt, Langensendelbach (DE); Joachim Grosse, Erlangen (DE); Jorg-Roman Konieczny, Siegburg (DE); Konrad Mund, Uttenreuth (DE); Manfred Poppinger, Uttenreuth (DE); Meike Reizig, Bonn (DE); Manfred Waidhas, Nurnberg (DE); Rittmar Von Helmolt, Mainz (DE)

Correspondence Address: LERNER & GREENBERG, P.A., PATENT ATTORNEYS AND ATTORNEYS AT LAW, Post Office Box 2480, Hollywood, FL, 33022-2480, US

(21) Appl. No.: 10/042,057

(22) Filed: Jan. 7, 2002

Related U.S. Application Data
(63) Continuation of application No. PCT/DE00/02169, filed on Jul. 4, 2000.

(30) Foreign Application Priority Data
Jul. 5, 1999 (DE) 199 30 877.2
Dec. 23, 1999 (DE) 199 62 681.2

(51) Int. Cl. H01M 8/04; H01M 8/10

(52) U.S. Cl. 429/23; 429/30; 429/26; 429/13

(57) ABSTRACT

A fuel cell installation and a method for operating a fuel cell installation with a dynamic power control are provided. The dynamic power control is achieved by additionally connecting at least one subsystem which is kept ready for operation, a starter system and/or a low-voltage unit for nighttime operation and/or an on-board power supply.

### CROSS-REFERENCE TO RELATED APPLICATION

This application is a continuation of copending International Application PCT/DE00/02169, filed Jul. 4, 2000, which designated the United States.

### BACKGROUND OF THE INVENTION

Field of the Invention

The invention relates to a fuel cell installation having at least one fuel cell stack and to a method for operating a fuel cell installation of this type.

A fuel cell installation which includes a plurality of fuel cell stacks is known, for example from European Patent No. EP 0 677 411 B1. This document discloses that the fuel cell module can be divided into a plurality of stacks in order to have an optimized construction, since either the number of individual cells required would otherwise overload a stack in a stationary fuel cell installation or the weight distribution of a drive unit in a vehicle requires the cells to be divided into two stacks.

Published, Non-Prosecuted German Patent Application Nos. DE 197 03 171 A and DE 196 37 207 A disclose in a similar manner in each case two fuel cell stacks. The two stacks are operated in coordination with one another, as a single installation. Furthermore, Japanese Patent Application No. JP 04-087262 A discloses an installation for energy generation using fuel cells, in which, in addition to fuel, the exhaust gas from the first fuel cell is also introduced into the second fuel cell.

The known configurations for fuel cell installations have hardly any way of achieving a dynamic power adjustment, for example during overtaking maneuvers, since they only provide for a continuous increase in the power through the use of a higher operating pressure, higher reaction-gas concentration, etc. A further drawback of the known systems with fuel cell installations is that neither low-voltage units nor additional units, for example for summertime and/or nighttime operation of the stationary fuel cell installation, for the on-board power supply or as an additional unit for dynamic operation of the mobile installation, are available.

### SUMMARY OF THE INVENTION

It is accordingly an object of the invention to provide a fuel cell installation which overcomes the above-mentioned disadvantages of the heretofore-known fuel cell installations of this general type and which achieves a dynamic power adjustment and/or provides a low-voltage unit. It is a further object of the invention to provide a method for operating such a fuel cell installation.

With the foregoing and other objects in view there is provided, in accordance with the invention, a fuel cell installation, including:

at least one fuel cell stack including individual fuel cell units;

the individual fuel cell units being electrically connected in series and being configured as separate subsystems; and

at least two of the separate subsystems being not identical and having at least one of separate voltage controls and separate power electronics.

In other words, the invention relates to a fuel cell installation which includes subsystems which can be operated separately and at least two of which are not identical, the subsystems having separate voltage control and/or power electronics. The invention also relates to a method for operating a fuel cell installation, in which at least two subsystems are operated separately.

According to another feature of the invention, at least two of the subsystems are electrically connected in parallel.

According to yet another feature of the invention, at least one of the subsystems includes a high-temperature polymer electrolyte membrane (HTM) fuel cell unit, a strip cell unit and/or a polymer electrolyte membrane (PEM) fuel cell unit.

According to a further feature of the invention, the at least one fuel cell stack includes a starter system and/or a low-voltage unit.

According to another feature of the invention, the starter system includes at least one polymer electrolyte membrane fuel cell unit.

According to yet another feature of the invention, at least two of the subsystems have respective cooling circuits assigned thereto, the cooling circuits are configured to be connectable in a series connection and/or a parallel connection.

According to another feature of the invention, an energy storage device, such as a battery, is operatively connected to the at least one fuel cell stack.

According to an advantageous configuration of the installation, the subsystems are electrically connected in series, in order to apply a maximum voltage of the system, for example when using small subsystems with a large number of cells but a small electrode surface. Cells of this type are also known as “strip cells” and are distinguished by the fact that there are different potentials in the cell plane of a fuel cell unit. This context is taken into account when configuring the starter system. To achieve the maximum current, subsystems with the same voltage, which are inherently connected in series, for example by strip cells, are connected in parallel. In this way, the voltage required to drive the electric motor can be ensured irrespective of the load.

With the objects of the invention in view there is also provided, a method for operating a fuel cell installation, the method includes the steps of:

providing at least one fuel cell stack including individual fuel cell units, the individual fuel cell units being electrically connected in series and being configured as separate subsystems, at least two of the separate subsystems being not identical and having separate voltage controls and/or separate power electronics; and

separately activating and/or separately operating the separate subsystems.

Another mode of the method according to the invention includes the step of operating the subsystems in respective continuous and discontinuous operation modes.

Yet another mode of the method according to the invention includes the step of starting at least one starter system at a beginning of a cold start of the at least one fuel cell stack.

A further mode of the method according to the invention includes the step of providing a modular media preparation for ensuring an optimized utilization of a fuel gas.

Another mode of the method according to the invention includes the step of operating, during an inoperative phase, a low-voltage subsystem and/or a low-current subsystem under maintenance load.

Another mode of the method according to the invention includes the step of connecting respective cooling circuits of at least two of the fuel cell units in series during a starting phase, an inoperative phase under maintenance load and/or a low load operating phase.

Yet another mode of the method according to the invention includes the step of drying the at least one fuel cell stack during an inoperative phase by heating the at least one fuel cell stack and/or blowing the at least one fuel cell stack dry, and protecting the at least one fuel cell stack from atmospheric humidity by closing valves or flaps.

A further mode of the method according to the invention includes the step of setting an efficiency of a subsystem toward an increased voltage or an increased thermal output by setting a cell voltage.

Other features which are considered as characteristic for the invention are set forth in the appended claims.

Although the invention is described herein as embodied in a fuel cell installation and a method for operating a fuel cell installation, it is nevertheless not intended to be limited to the details described, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments.

### DESCRIPTION OF THE PREFERRED EMBODIMENTS

A fuel cell installation according to the invention includes separate subsystems. The terms “subsystem” denotes a stack including at least one fuel cell unit. A plurality of subsystems may be accommodated either in one housing or in separate housings.

By way of example, two subsystems can be activated, operated, actuated and controlled separately, i.e. independently. Each of the subsystems provides the entire operating voltage, except that one subsystem is used only as a low-voltage unit. The independent characteristics of the subsystems encompass both the time component and the operational component, i.e. the subsystems can on the one hand be operated in succession and on the other hand in parallel with a different operating mode. A combination of the two variants, in which one subsystem is started later and is run under different operating conditions, is also included.

By way of example, a system includes three subsystems numbered 1, 2, and 3 with the following power distribution: 10 kW, 20 kW and 20 kW again. A 20 kW block is sufficient for starting, given an appropriate voltage, and if necessary the other blocks are then connected up in order to dynamically increase the power. Each subsystem provides the full starting and/or operating voltage.

According to another example, the steps are connected in parallel and/or in series: in the example, the fuel cell installation 3 has separate stacks, which can be connected in series and/or in parallel: stack 1 is used to supply the stationary current and has a low operating voltage (number of electrodes) and a medium power output (electrode surface area), stack 2 has a higher number of electrodes (voltage) and likewise a medium power output, and finally stack 3 has the full operating voltage with a high power output, but it takes a long time for it to reach operating temperature. If stacks 1 and 2 are connected in series, they also provide the full operating voltage, i.e. the voltage which the system needs to start and which, for example, corresponds to the voltage of the stack 3; although they cannot provide the ultimate output (with regard to current/electrode surface area) of the system, they quickly reach operating heat and are ready for use. Stacks 1 and 2 connected in series are able to start the vehicle, and as soon as stack 3 has reached its operating temperature it takes over the driving, while stack 1 and stack 2 are switched off or can, for example during overtaking maneuvers, be switched on again, while stack 1 can be used separately for on-board power supply if the total power of all three stacks is not required for driving. For operation on the expressway, it is even possible for stacks 1 and 2, connected in series, to be connected in parallel with stack 3, in which case all the electrode surfaces of the three separate stacks would be used to generate power and to drive the vehicle.

According to a further example, the system includes 10 subsystems, each providing 5 kW. This makes maintenance/repair work particularly easy, since the individual systems are small and easy to exchange in the event of faults or maintenance.

Depending on requirements, a subsystem which can be switched on may include conventional fuel cells (large-area, high-amp fuel cell) or strip cells (small area, high voltage when connected in series), in which case the requirement may either be a higher voltage or more current.

According to the invention, the subsystems may or may not be identical. In particular, they may or may not be identical with regard to power, size, material, output and/or type of fuel cell, such as for example conventional fuel cell (uniform potential on the baseplate) and/or strip cell (different potentials on the baseplate); PEM, HTM fuel cell, PAFC (Phosphoric Acid Fuel Cell) fuel cell, MCFC (Molten Carbonate Fuel Cell), DMFC (Direct Methanol Fuel Cell) and/or SOFC (Solid Oxide Fuel Cell) fuel cell.

If it is desired for the power output of the subsystems to be connected in parallel or optimized and there is a considerable difference in size between the subsystems, the use of strip cells, in which the electrical cell surface is reduced in size, is preferred.

The term “can be operated separately” is understood as meaning that the subsystems can be activated and kept running independently, i.e. separately. The subsystems are activated, for example, by cooling, by the supply of process gas and/or electrically. In this case, one subsystem can preheat the other, for example through the use of its exhaust gas.

HTM fuel cells are described in a further application filed by the same applicant and having the same title, the content of which is hereby referred to in its entirety.

An HTM (high-temperature polymer electrolyte membrane) fuel cell, also known as an HTM fuel cell unit, includes the following components. A membrane and/or matrix, which contains a self-dissociating and/or autoproteolytic electrolyte in chemically and/or physically bound form, two electrodes, which are on opposite sides of the membrane and/or matrix. Adjacent to at least one electrode, a reaction chamber which is closed off from the environment by in each case a terminal plate and/or a corresponding edge structure, devices which can be used to introduce and discharge the process gas into and from the reaction chamber being provided. The structural components of the HTM fuel cell are formed in such a way that they are able to withstand reduced pressure down to approx. 0.3 bar and temperatures up to 300° C. for a prolonged period.

According to an advantageous mode of the method according to the invention, the fuel cell installation is run in combined continuous and discontinuous operation, i.e. within an operating phase, at least one further subsystem can be switched on quickly for power peaks, so that good power dynamics for use of the installation in mobile and stationary systems are produced.

To make the cold start easier, according to one embodiment at least one small subsystem, e.g. a low-voltage system as heating, is run in permanent operation, so that it either keeps the operating temperature or some other temperature above the crystallization point of the electrolyte (e.g. above 40° C.) and can then be used to heat up the remaining subsystems in order for the installation to start. In the configuration of the method in which a subsystem is run in permanent operation, this subsystem is preferably operated with maximum thermal output at least during the inoperative phase, in which it is used to maintain the minimum temperature (e.g. for an autothermal starting operation). The term inoperative phase is used to indicate the time during which the fuel cell system is switched off.

Depending on requirements, the efficiency of the subsystem may be controlled toward higher current generation or higher thermal output by setting the cell voltage. The control may in this case also take place through the use of a control unit in accordance with a predetermined algorithm, taking account of a number of measurement data and/or of the desired current output, heating output and/or the driver's wishes, etc. Setting to achieve a higher thermal output is preferably used to maintain the operating temperature.

In one mode of the method according to the invention, although the “starter system” is not run in permanent operation, either, during a cold start, initially only this relatively small subsystem is heated, or a temperature which is higher than the crystallization point of the electrolyte is reached in the subsystem through the use of insulation, a latent heat store and/or heating, so that autothermal heating of the starter system can take place. In this case, it is advantageous if there is a PEM/HTM system combination, in which the PEM system is the starter system, since the PEM system can be started autothermally even at temperatures which are only just above 0° C., whereas an HTM system with a broenstedt acid, such as for example phosphoric acid, as electrolyte can only be started autothermally at temperatures of over 40° C. It is also possible to provide an additional energy store, such as a battery, for standby mode. The term “starter system” denotes the subsystem which allows partial load operation which, during the transition to the next, higher load phase (switching on further subsystems) and/or during the transition to full-load operation, heats up further subsystems both through the use of the waste heat and through the use of electrical power output, and these subsystems can the be connected up.

Irrespective of the starter system, according to an advantageous configuration an additional energy store, such as for example a battery, is provided, which, for example in the case of mobile applications, provides the drive unit with the energy required for starting and at least 3-5 minutes of driving time.

The waste heat from a smaller subsystem, for example the waste heat from the low-voltage or starter system, can be used to heat the inhabited room or passenger compartment.

According to an advantageous configuration of the fuel cell installation and of the operating method, a modular media preparation is provided, so that the peripherals of the installation, such as for example fuel cell stack, reformer, compressor (blower) and fan can each be operated in their optimum operating range.

Accordingly, the units in the stack peripherals can be in the form of a plurality of modules including smaller units, so that, for example, during partial-load operation of a fuel cell stack, one reformer module of a number of such modules is operated at full load, each of the appliances then running in their optimum operating range, i.e. with optimum utilization of fuel.

The mean size of an HTM or PEM fuel cell subsystem in a fuel cell installation which is used for electrical traction includes, for example, 300 fuel cell units for electrical traction.

A starter system supplies the voltage which is required for starting, e.g. 100-500 V, preferably 200 V; an output in the range from 1 to 35 kW, in particular between 10 and 20 kW, is sufficient. According to one embodiment, the starter system at least in part includes strip cells, so that the required voltage can be produced within a small space.

A system which is used for the low-voltage on-board power supply (e.g. the 42 volt vehicle electrics system) includes, for example, 20-60 fuel cell units and has a maximum output of approx. 1 to 10 kW.

During starting and/or during the inoperative phase during which the operating temperature is maintained (maintenance load) and/or during an operating phase involving a low load (idling), it is appropriate for the cooling to be connected in series, so that the cooling of one subsystem can be used as heating for another subsystem. In this case, it is also advantageous if, in the case of air operation, a plurality of stacks are connected in series, so that the waste air from the first stack can be used to heat the next stack. Connecting the stacks in series may also be advantageous during single-stack operation of the multistack system, since the heat from the waste air from the stack which is operating is used to maintain the operating temperature of the stack which is currently not operating. The installation of an air filter for cooling and/or reaction air is advantageous.

According to one configuration of the installation, at least two subsystems include HTM fuel cells. In this embodiment, it is preferable for the cooling of the two subsystems, when the operating temperature has been reached, to be connected in parallel, since the two subsystems are at the same operating temperature.

In the case of subsystems with a similar or identical operating temperature, it is preferred for the cooling to be connected in parallel during normal operation.

At temperatures of below 120° C. and/or on account of the emissions limits which have to be observed, gas cleaning is preferably provided in an HTM subsystem with reformer, in order to remove CO from the process gas or to reduce the CO content of the residual gas.

According to one configuration of the installation, at least one subsystem includes at least one HTM fuel system and a subsystem includes at least one polymer electrolyte membrane (PEM) fuel cell.

In this configuration, when the operating temperature has been reached, the cooling of the two subsystems can be connected in series, since the heated cooling medium from the PEM fuel cell subsystem is still cool enough to cool the subsystem with HTM fuel cells, which are operated at a considerably higher temperature.

It is also possible, in the combination of at least one PEM fuel cell subsystem with an HTM fuel cell subsystem, to provide a two-part cooling system, which includes a low-temperature cooling circuit and a high-temperature cooling circuit. In the case of a PEM fuel cell subsystem, CO gas cleaning, for example in the form of a hydrogen-permeable barrier membrane, is provided.

This combination is particularly suitable for an installation with on-board power supply, the PEM subsystem preferably being used for the low-voltage on-board power supply.

According to an advantageous configuration of the method, the fuel cell installation is dried by heating during the inoperative phase, so that, for example during short-time operation, when inoperative and/or load phases are short, the stack temperature is essentially kept above the boiling point of water. This can be achieved, for example, by setting a maintenance load during the inoperative phase. The maintenance load set can preferably be adjusted, so that it is possible to distinguish between the fuel cell installation being switched off for three weeks or three hours.

According to another configuration of the method, when the installation is shut down, at least one subsystem and/or a cooling system is blown through and/or blown dry—either in combination with the drying by heating or as a standalone measure—using process gas and/or inert gas, so that during starting the installation is as free from water as possible and/or the cooling system is as empty as possible. Emptying of the cooling system is in this case completely independent of the drying of the stack by blowing it dry.

Ongoing monitoring of the water content of the emerging process gas and/or inert gas during the blowing-dry operation indicates when the cell/the stack is dry and the blower or compressor can be switched off. Then, the control mechanism which is used to admit the air for the blowing-dry operation is preferably closed, and in this way the stack is shut off from any atmospheric humidity.

The cooling medium which is stored externally during the inoperative phase according to one variant of this method can be heated externally, during starting and/or before starting, for example by a stack of the installation which is provided for this purpose, by utilization of waste heat and/or through the use of a latent heat store, and can be admitted as heating medium to the cooling system of a subsystem which is to be started.

The blower required for this purpose may be the compressor and is supplied, for example, with power from the and/or another subsystem of the fuel cell installation and/or via an external energy store, in particular an electrical energy store.

A subsystem of the fuel cell installation may be provided for the purpose of supplying starting current, for example for supplying the units such as heating for process-gas preheating, compressor, reformer, blower, etc.

The term fuel cell installation is used to denote the entire fuel cell system, which includes at least two subsystems, which either form two separate stacks or are integrated in a housing. The subsystems each have at least one fuel cell unit, the corresponding process-gas feed and discharge ducts, the end plates, the cooling system with cooling medium and all the fuel cell stack peripherals (reformer, compressor, blower, heating for process-gas preheating, etc.).

The term stack denotes the stack including at least one fuel cell unit with the associated lines and at least part of the cooling system.

A fuel cell unit includes at least one membrane and/or matrix with a chemically and/or physically bound electrolyte, two electrodes, which are on opposite sides of the membrane and/or matrix, adjacent to at least one electrode a reaction chamber, which is closed off from the environment by in each case a terminal plate and/or a corresponding edge structure, devices which can be used to introduce and discharge the process gas into and from the reaction chamber being provided. The fuel cell installation according to the invention allows, for example, differentiated power output, which can be dynamically adjusted to the particular conditions, from the installation. Moreover, a subsystem may be provided for connecting up only when accelerating, this subsystem, while it is inoperative, always being kept at operating temperature through the use of the cooling circuit of another subsystem, which is operating, through the use of a latent heat store or through the use of some other device (heating, insulation, maintenance load). Latent heat stores for more rapid heating of the cooling water in motor vehicles are known. The storage media used are what are known as phase change materials, such as barium hydroxide, etc. The heat uptake or dissipation is effected by melting or recrystallization of the materials.

A further option which is presented for the first time by the system is for a subsystem to be configured as a “low-voltage unit” or “starter subsystem” for summertime or nighttime operation, for starting and/or for on-board power supply (continuous current heating, air-conditioning unit, heating, radio, etc.) as an APU (Auxiliary Power Unit). This subsystem can then be operated with a low rated output, for example 1 to 50 kW (corresponds to approx. 5 to 20% of the rated output of the overall system). By its nature, the starter system differs from the low-voltage unit by the voltage which it produces, since the starter system supplies the voltage which the vehicle needs in order to start up.

We claim:

1. A fuel cell installation, comprising:
at least one fuel cell stack including individual fuel cell units;
said individual fuel cell units being electrically connected in series and being configured as separate subsystems; and
at least two of said separate subsystems being not identical and having at least one of separate voltage controls and separate power electronics.

2. The fuel cell installation according to claim 1,
wherein at least two of said subsystems are electrically connected in parallel.

3. The fuel cell installation according to claim 1,
wherein at least one of said subsystems includes at least one unit selected from the group consisting of a high-temperature polymer electrolyte membrane fuel cell unit, a strip cell unit and a polymer electrolyte membrane fuel cell unit.

4. The fuel cell installation according to claim 1,
wherein said at least one fuel cell stack includes at least one element selected from the group consisting of a starter system and a low-voltage unit.

5. The fuel cell installation according to claim 4,
wherein said starter system includes at least one polymer electrolyte membrane fuel cell unit.

6. The fuel cell installation according to claim 1,
wherein at least two of said subsystems have respective cooling circuits assigned thereto, said cooling circuits are configured to be connectable in at least one of a series connection and a parallel connection.

7. The fuel cell installation according to claim 1, including an energy storage device operatively connected to said at least one fuel cell stack.

8. The fuel cell installation according to claim 7,
wherein said energy storage device is a battery.

9. A method for operating a fuel cell installation, the method which comprises:
providing at least one fuel cell stack including individual fuel cell units, the individual fuel cell units being electrically connected in series and being configured as separate subsystems, at least two of the separate subsystems being not identical and having at least one of separate voltage controls and separate power electronics; and
at least one of separately activating and separately operating the separate subsystems.

10. The method according to claim 9, which comprises operating the subsystems in respective continuous and discontinuous operation modes.

11. The method according to claim 9, which comprises starting at least one starter system at a beginning of a cold start of the at least one fuel cell stack.

12. The method according to claim 9, which comprises providing a modular media preparation for ensuring an optimized utilization of a fuel gas.

13. The method according to claim 9, which comprises operating, during an inoperative phase, at least one subsystem selected from the group consisting of a low-voltage subsystem and a low-current subsystem under maintenance load.

14. The method according to claim 9, which comprises connecting respective cooling circuits of at least two of the fuel cell units in series during at least one operating phase selected from the group consisting of a starting phase, an inoperative phase under maintenance load and a low load operating phase.

15. The method according to claim 9, which comprises:
drying the at least one fuel cell stack during an inoperative phase by at least one of heating the at least one fuel cell stack and blowing the at least one fuel cell stack dry; and
protecting the at least one fuel cell stack from atmospheric humidity by closing one of valves and flaps.

16. The method according to claim 9, which comprises setting an efficiency of a subsystem toward one of an increased voltage and an increased thermal output by setting a cell voltage.
